(19) United States
(12) Patent Application Publication
(10) Pub. No.: US 2004/0068839 A1
(43) Pub. Date: Apr. 15, 2004

(54) Vehicle sunshade guide mechanism

(76) Inventors: Daniel Hock, Johannesberg (DE); Alexander Buttner, Bessenbach (DE)

Correspondence Address: CARLSON, GASKEY & OLDS, P.C., 400 WEST MAPLE ROAD, SUITE 350, BIRMINGHAM, MI, 48009, US

(21) Appl. No.: 10/664,124

(22) Filed: Sep. 17, 2003

(30) Foreign Application Priority Data
Sep. 30, 2002 (DE) 102 45 929.0

(51) Int. Cl. E05D 13/00

(52) U.S. Cl. 16/215

(57) ABSTRACT

A guide mechanism for a vehicle sunshade, such as a roller blind or sliding headliner, includes at least one guide rail and a sliding carriage shiftable in the guide rail. The guide rail has a brake face and the sliding carriage includes a brake member that cooperates with the brake face to lock the sliding carriage in place in the guide rail. The sliding carriage has at least one spring acting upon the sliding carriage so that the brake member presses against the brake face. The sliding carriage also has at least one tilt edge spaced away from the brake member so that the sliding carriage can be swiveled about the tilt edge against the biasing force of the spring, causing the brake member to be released from the brake face.

### REFERENCE TO RELATED APPLICATIONS

The present invention claims the benefit of German Patent Application No. 102 45 929.0, filed Sep. 30, 2002.

### TECHNICAL FIELD

The invention relates to a motor vehicle sunshade guide mechanism, and more particularly a guide mechanism containing at least one guide rail and a sliding carriage adapted to be shifted in the guide rail.

### BACKGROUND OF THE INVENTION

Vehicle sunshades, such as a roller blind or a sliding headliner, require a guide mechanism to move the sunshade smoothly. A sunshade guide mechanism may contain at least one guide rail and a sliding carriage adapted to be shifted in the guide rail.

One demand made on the sliding carriage is that it should be easy to move within the guide rail to minimize the actuating forces required for shifting the roller blind or the sliding headliner toward the front or toward the rear. However, the sliding carriage must also remain in its respective selected position in the guide rail to prevent the roller blind or the sliding headliner from any unintentional movement while the vehicle is in motion, especially if the sunshade is affected by the forces from a retracting spring which is often used for roller blinds.

There is a desired for a vehicle sunshade guide system that can accommodate both of these demands.

### SUMMARY OF THE INVENTION

The invention provides a guide mechanism that satisfies both demands, allowing the sliding carriage to be shifted easily in the guide rail with particular ease and at the same time be reliably locked in place in its respective position. For this purpose, in accordance with one embodiment of the invention, the guide rail has a brake face and the sliding carriage includes a brake member that cooperates with the brake face so that the sliding carriage is locked in place in the guide rail. The sliding carriage has at least one spring acting upon the sliding carriage so that the brake member presses against the brake face. The sliding carriage also has at least one tilt edge spaced away from the brake member so that the sliding carriage can be swiveled about the tilt edge against the biasing force of the spring, causing the brake member to be released from the brake face.

In this design, the brake member is automatically released from the brake face as soon as the sliding carriage is released in the guide rail to tilt about the tilt edge at the same time. Once adjustment of the sliding carriage in the guide rail is complete, the carriage is pressed back by the spring into its initial position, causing the brake member to abut the brake face. The sliding carriage is therefore reliably and securely locked back in place.

According to one embodiment of the invention, the sliding carriage is symmetrical relative to a transverse plane extending through the brake member, and a tilt edge is provided at each end of the sliding carriage. Furthermore, a spring may be provided on either side of the transverse plane. In this configuration, depending on the direction in which the sliding carriage is shifted in the guide rail, the sliding carriage will tilt about one of the tilt edges. More specifically, the sliding carriage will tilt about the tilt edge that is located at the front in the respective direction of adjustment.

In one embodiment, the tilt edge and the part of the spring that contacts the guide rail are made of a material having a low coefficient of friction. This ensures that the sliding carriage can be adjusted in the guide rail with little friction restricting ease of movement. Preferably, the entire body of the sliding carriage is made of a material having a low coefficient of friction.

According to one embodiment of the invention, the spring is a leaf spring having a support cap at its free end. The support cap is made of a material having a low coefficient of friction. The leaf spring can be cast into the body of the sliding carriage to minimize manufacturing costs.

According to one embodiment of the invention, the brake face is formed by two side faces of a groove located obliquely opposite each other, with a pair of braking members arranged on opposite sides of the sliding carriage. Because the spring presses the two brake members against the obliquely arranged side faces of the groove, a wedging effect is produced, resulting in a distinct increase in the braking force.

In one embodiment, the guide mechanism includes two guide rails disposed opposite each other, each having a sliding carriage arranged therein. The two sliding carriages are connected to each other by a crosspiece to which a handle is fitted. The handle will typically be arranged below the guide rail so that, when operated, it will automatically produce the necessary tilting movement of the two sliding carriages in the guide rail to free the brake members from their respective brake surfaces.

### BRIEF DESCRIPTION OF THE DRAWINGS

The invention will now be described with reference to a preferred embodiment illustrated in the accompanying drawings in which:

FIG. 1 shows a representative side view of a guide rail and a sliding carriage in the locked condition;

FIG. 2 shows a section view taken along the plane II of FIG. 1;

FIG. 3 shows a section view taken along the plane III of FIG. 1;

FIG. 4 shows a section view taken along the plane IV of FIG. 1;

FIG. 5 shows a representative side view of a guide rail and a sliding carriage, the sliding carriage being in a first released condition;

FIG. 6 shows a section view taken along the plane VI of FIG. 5;

FIG. 7 shows a section view taken along the plane VII of FIG. 5;

FIG. 8 shows a section view taken along the plane VIII of FIG. 5;

FIG. 9 shows a representative side view of a guide rail and a sliding carriage, the sliding carriage being in a second released condition;

FIG. 10 shows a section view taken along the plane X of FIG. 9;

FIG. 11 shows a section view taken along the plane XI of FIG. 9;

FIG. 12 shows a section view taken along the plane XII of FIG. 9;

FIG. 13 shows a representative perspective view of a sliding carriage with a crosspiece fitted thereto; and

FIG. 14 shows another representative perspective view of the sliding carriage of FIG. 13.

### DETAILED DESCRIPTION OF THE EMBODIMENTS

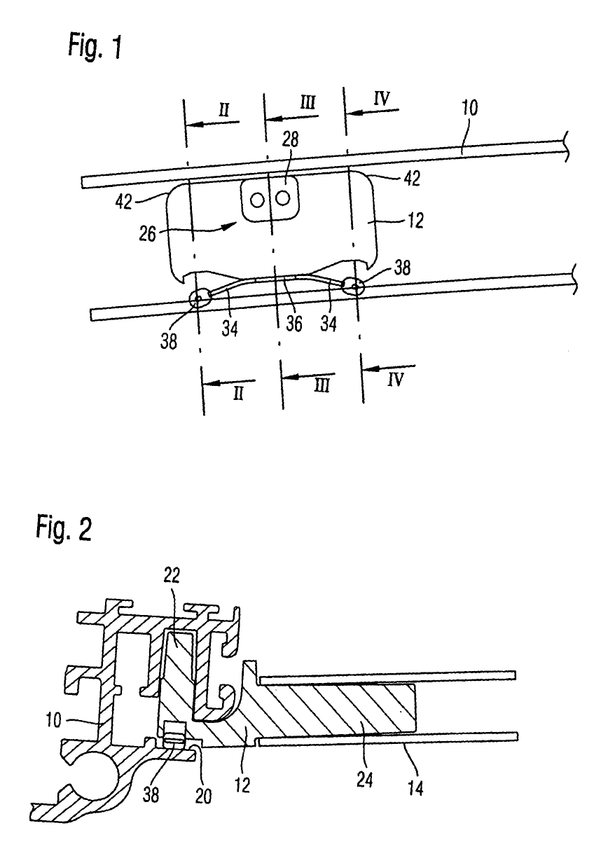

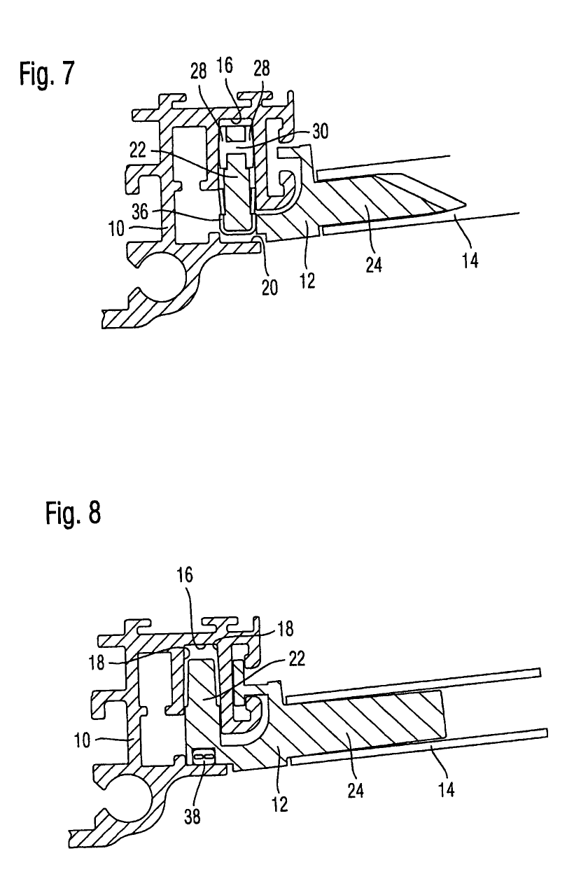

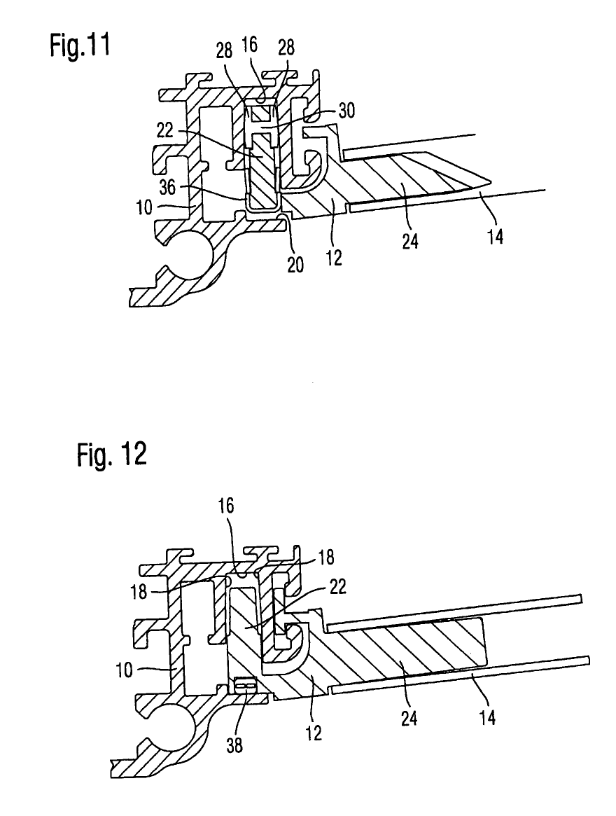

FIGS. 1 through 12 show a guide rail 10 with a sliding carriage 12 disposed to be shifted therein. The guide rail 10 is fitted to the roof of a vehicle and extends roughly parallel to the longitudinal direction of the vehicle. In a typical guide system, two guide rails are arranged opposite each other and typically extend parallel to each other. Accordingly, the guide system also includes two sliding carriages 12 that are likewise arranged opposite each other. The sliding carriages 12 are connected to each other by a crosspiece 14 which consequently extends at right angles with respect to the longitudinal direction of the vehicle.

A sunshade (not shown), such as a roller blind or sliding headliner, is connected to the crosspiece and is arranged below a roof opening adapted to be closed by a cover of a sliding roof system. For simplicity, the examples below will focus on a roller blind, but the invention is applicable to other types of sunshades as well.

In one embodiment, the roller blind is received in a housing at its rear end with respect to the direction of travel of the vehicle and may be pulled out of the housing toward the front, against the biasing force a retracting spring. At its front end, the roller blind is located by the crosspiece 14 and the two sliding carriages 12 in the inventive guide assembly. The two sliding carriages 12 lock the roller blind in place in the guide rail in any desired position to prevent it from being unintentionally retracted back into the housing by the biasing force of the retracting spring.

In one embodiment, each guide rail 10 is embodied in the form of a deep-drawn profiled part made from an aluminum alloy and has a guide groove 16 in which the sliding carriage 12 is arranged. The guide groove 16 features a pair of side faces 18 arranged obliquely opposite each other to act as brake faces. The guide rail is provided with a support face 20 on the side opposite the bottom of the guide groove 16.

The sliding carriage 12 has a generally rectangular body 22 disposed within the space between the guide groove 16 and the support face 20. A connecting extension 24 connected to the crosspiece 14 projects laterally from the body 22. A brake member 26 is arranged on the side of the body 22 disposed in the guide groove 16. The brake member 26 is preferably made of plastic rubber, or other material having a high coefficient of friction and includes a pair of cushions 28 on the outside that are connected to each other by a connecting bridge 30. The two cushions 28 rest on the outer faces of the body 22 and are associated with the side faces 18 of the guide groove 16.

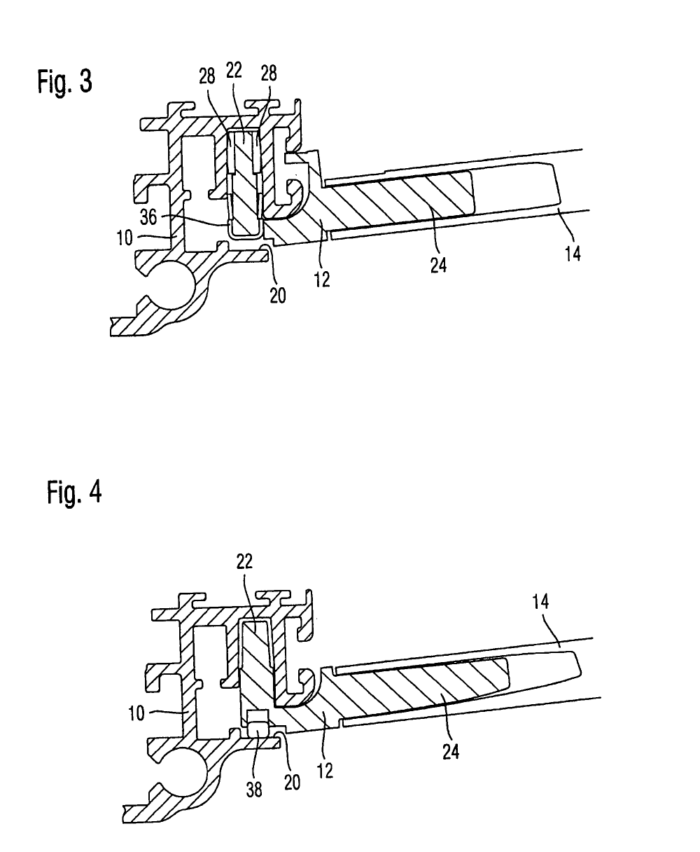

On the side facing away from the bottom of the guide groove 16, the body 22 of the sliding carriage 12 is provided with a spring 32. In one embodiment, the spring 32 is configured as a leaf spring having a pair of spring arms 34 and a central section 36. The central section 36 engages around the body 22 of the sliding carriage 12 from the side (see FIG. 3) so that the spring 32 is securely fixed to the carriage 12. The two spring arms 34 extend in the longitudinal direction of the body 22 and have a support cap 38 on each free end. Each support cap 38 is made of a material having a low coefficient of friction and is supported on the support face 20 of the guide rail 10. In one embodiment, the material of the support caps 38 is the same as the material of the body 22 of the sliding carriage 12 so that the body 22 also has a low coefficient of friction in relation to the guide rail 10.

As can be seen in FIG. 1, the sliding carriage 12 is constructed to be mirror-symmetrical with respect to a central plane, which in this example coincides with the sectional plane III.

In the initial condition as shown in FIGS. 1 through 4, the body 22 of the sliding carriage 12 is pressed into the guide groove 16 by the spring 32, whose support caps 38 are supported on the support face 20 of the guide rail 10. In this position, the two cushions 28 of the brake member 26 rest against the side faces 18 of the guide groove 16. As noted above, the side faces 18 of the guide groove 16 act as brake faces. Because the side faces 18 of the guide groove 16 are disposed obliquely to the direction of action of the spring 32, a wedging action increases the force applied to the brake member 26 by the side faces 18, causing the sliding carriage 12 to be reliably locked in place at a selected position in the guide rail 10. The braking forces at the interface between the side faces 18 and the cushions 28 of the brake member 26 are large enough to prevent the sliding carriage 12 and the crosspiece 14 connected to it from being inadvertently shifted in the guide rail 10 by the return spring biasing forces acting on the roller blind by its associated spring.

Alternatively, the brake member 26 may include one single cushion rather than two cushions 28 on the outer sides as described above. In this embodiment, the single cushion is arranged centrally on the side of the carriage body 22 facing the bottom of the guide groove 16. The brake member 26 may also incorporate the centrally-disposed cushion in addition to the two cushions 28 on the outer sides. The brake member 26 may also be designed with a bridge configuration connecting the two outer cushions with each other.

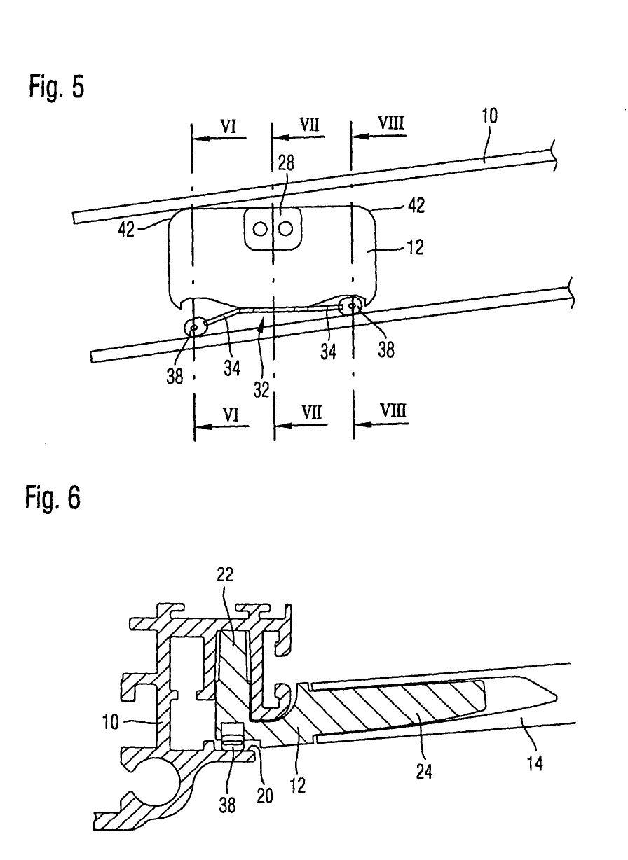

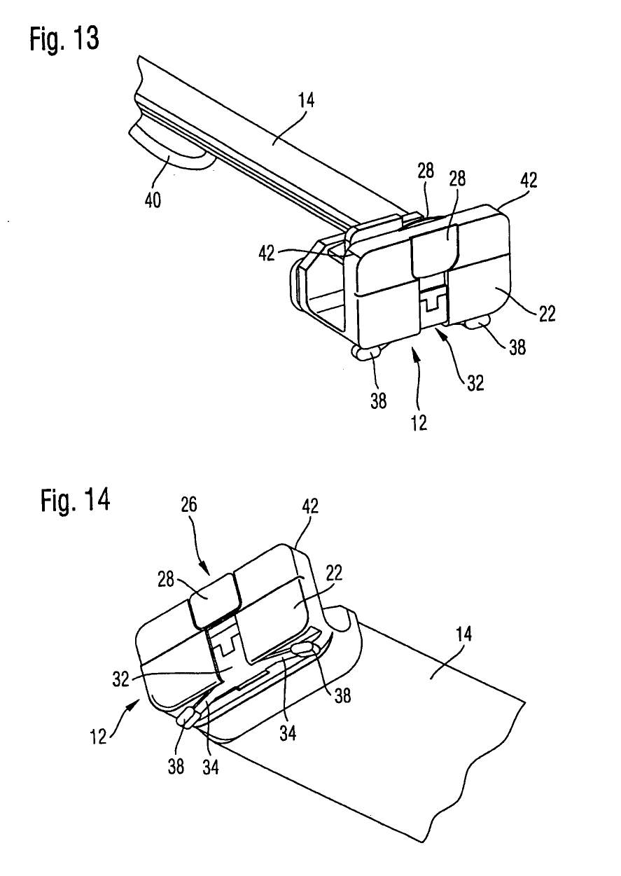

When a user wishes to adjust the roller blind, he grasps a handle 40 (FIG. 13) attached to the crosspiece 14 to pull the crosspiece 14 toward the front or toward the rear. Because the handle 40 is disposed below the sliding carriage 12, moving the handle 40 toward the front causes the sliding carriage 12 to pivot into the position shown in FIGS. 5 through 8, biasing the rear spring arm 34. In the pivoted position, the upper end of the body 22 of the sliding carriage 12, which is the front end in relation to the vehicle in this example, acts as a tilt edge 42 supported by the bottom of the guide groove 16 of the rail 10. At the same time, the upper rear end of the sliding carriage 12 moves away from the bottom of the guide groove 16. This swiveling movement of the carriage 12 within the guide rail 10 causes the two cushions 28 to be released from the side faces 18 of the guide groove 16, freeing the sliding carriage 12 to allow the carriage 12 to move easily.

The carriage may then be shifted in the guide rail 10 against a minor resistance caused by the low friction between the tilt edge 42 of the body 22 and the bottom of the guide groove 16, on the one hand, and between the support cap 38 of the spring 32 and the support face 20 of the rail 10, on the other hand. As soon as the handle 40 is released again, the biased spring arm 34 at the rear presses the sliding carriage 12 back into the initial position shown in FIGS. 1 through 4, causing the cushions 28 to be pressed between the side faces 18 of the guide groove 16 to lock the sliding carriage 12 in place.

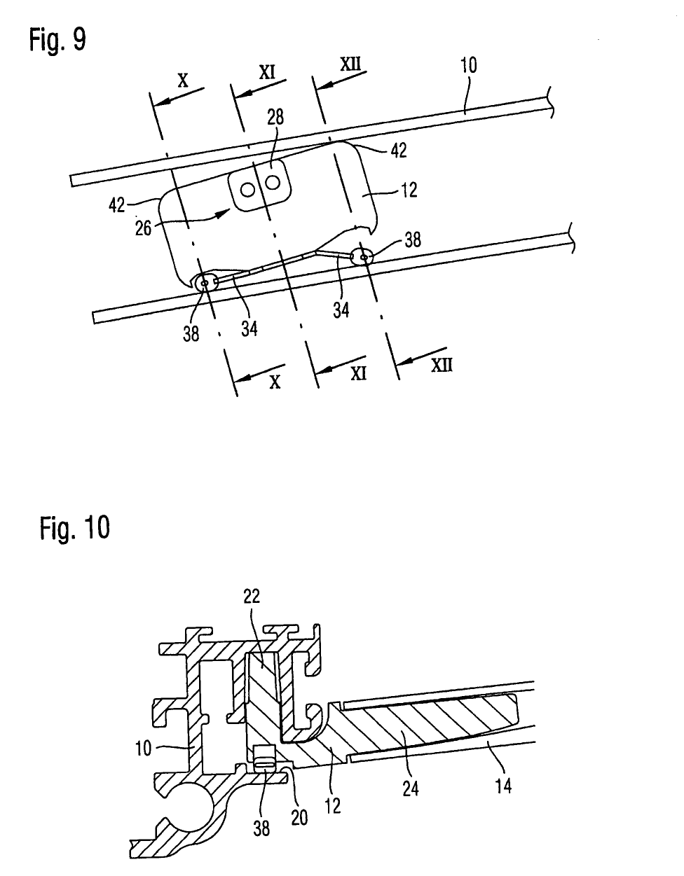

FIGS. 9 through 12 show the sliding carriage 12 in the position it will assume when the crosspiece 14 is shifted toward the rear along with the two sliding carriages 12 in the guide rail 10. Because the body 22 is mirror-symmetric, no further explanations are required in this connection.

It should be understood that various alternatives to the embodiments of the invention described herein may be employed in practicing the invention. It is intended that the following claims define the scope of the invention and that the method and apparatus within the scope of these claims and their equivalents be covered thereby.

1. A sunshade guide mechanism, comprising:
at least one guide rail having a brake face; and
a sliding carriage shiftable in the guide rail, the sliding carriage having
a body that shifts in the guide rail,
a brake member connected to the body and that cooperates with the brake face to lock the sliding carriage in the guide rail,
at least one spring having a biasing force that acts upon the sliding carriage to press the brake member against the brake face, and
at least one tilt edge spaced away from the brake member, wherein the sliding carriage can be swiveled about the tilt edge against the biasing force of the spring to release the brake member from the brake face.

2. The guide mechanism as claimed in claim 1, wherein the sliding carriage is symmetrical in relation to a transverse plane extending through the brake member.

3. The unit as claimed in claim 2, further comprising a spring arm on the sliding carriage on either side of the transverse plane.

4. The unit as claimed in claim 1, wherein the tilt edge and a portion of the spring arm contacting the guide rail are each made of a material having a low coefficient of friction.

5. The unit as claimed in claim 4, wherein the spring arm is a leaf spring having at least one free end, and wherein the guide mechanism further comprises a support cap disposed on said at least one free end, wherein the support cap has a low coefficient of friction.

6. The guide mechanism according to claim 1, wherein said at least one tilt edge comprises a first tilt edge at a first end of the sliding carriage and a second tilt edge at a second end of the sliding carriage.

7. The guide mechanism as claimed in claim 1, wherein the entire body of the sliding carriage is made of a material having a low coefficient of friction.

8. The guide mechanism as claimed in claim 1, wherein the brake member is made of a material having a high coefficient of friction.

9. The guide mechanism as claimed in claim 1, wherein the brake face comprises two side faces of a groove in said at least one guide rail, wherein the two side faces are disposed obliquely opposite each other.

10. The guide mechanism as claimed in claim 1, wherein the brake member comprises a pair of braking cushions arranged on opposite sides of the sliding carriage.

11. The guide mechanism as claimed in claim 1, wherein said at least one guide rail comprises two guide rails disposed opposite each other, and wherein the guide mechanism further comprises a second sliding carriage, each sliding carriage disposed in one of said two guide rails.

12. The guide mechanism as claimed in claim 11, further comprising a crosspiece connecting the two sliding carriages.

13. The guide mechanism as claimed in claim 12, further comprising a handle attached to the crosspiece.

14. A sunshade guide mechanism, comprising:
two guide rails disposed opposite each other, each guide rail having a brake face;
two sliding carriages, each carriage disposed in one of said two guide rails, each sliding carriage having
a body that shifts in the guide rail,
a brake member connected to the body and that cooperates with the brake face to lock the sliding carriage in the guide rail, wherein the sliding carriage is symmetrical in relation to a transverse plane extending through the brake member, wherein the brake member is made of a material having a high coefficient of friction,
at least one spring having a biasing force that acts upon the sliding carriage to press the brake member against the brake face, and
a first tilt edge at a first end of the sliding carriage and a second tilt edge at a second end of the sliding carriage, the first and second tilt edges being spaced away from the brake member,
wherein the sliding carriage can be swiveled about the first and second tilt edges against the biasing force of the spring to release the brake member from the brake face, wherein the tilt edge and a portion of the spring arm contacting the guide rail are each made of a material having a low coefficient of friction; and
a crosspiece connecting the two sliding carriages.

15. The sunshade guide mechanism as claimed in claim 14, further comprising a spring arm on the sliding carriage on either side of the transverse plane.

16. The sunshade guide mechanism as claimed in claim 14, wherein the spring arm is a leaf spring having at least one free end, and wherein the guide mechanism further comprises a support cap disposed on said at least one free end, wherein the support cap has a low coefficient of friction.

17. The guide mechanism as claimed in claim 14, wherein the entire body of the sliding carriage is made of a material having a low coefficient of friction.

18. The guide mechanism as claimed in claim 14, wherein the brake face comprises two side faces of a groove in each of the guide rails, wherein the two side faces are disposed obliquely opposite each other.

19. The guide mechanism as claimed in claim 14, wherein the brake member comprises a pair of braking cushions arranged on opposite sides of the sliding carriage.

20. The guide mechanism as claimed in claim 14, further comprising a handle attached to the crosspiece.
